(19) United States
(12) Patent Application Publication
(10) Pub. No.: US 2002/0114489 A1
(43) Pub. Date: Aug. 22, 2002

(54) Method of using associated data in watermark detection

(76) Inventors: Michael S. Ripley, Hillsboro, OR (US); Brendan S. Traw, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/790,364

(22) Filed: Feb. 21, 2001

(51) Int. Cl. G06K 9/00

(52) U.S. Cl. 382/100

(57) ABSTRACT

Avoiding transitory uncertainty caused by delayed watermark detection by a device in a content protection system may be accomplished by receiving content having a watermark from a content source, receiving a request for action to process the received content, checking the received content for data associated with the watermark, performing at least one of halting and preventing the requested action when associated data is found in the received content and the associated data indicates that the requested action is not permitted, and beginning the requested action when associated data is found in the received content and the associated data indicates that the requested action is permitted.

### BACKGROUND

1. Field

The present invention relates generally to content protection and security in computer and consumer electronics systems and, more specifically, to using associated data to avoid transitory uncertainty caused by delayed watermark detection.

2. Description

A number of systems for protecting content (e.g., against unauthorized copying) have been developed that employ watermarking as a part of the protection scheme. Watermarking is a technique whereby information is embedded into content in such a way that is transparent to users of the content, is difficult to remove from the content, and can be robustly detected in the content by specialized hardware or software. In some systems, the watermark data may indicate conditions and requirements constraining use of the content, including constraints specific to copying. A recording device that is compliant with such a system may be required to detect the watermark in content that is to be copied. If the watermark is present, the device only makes such a copy in a manner that is permitted by the watermark. If the watermark data indicates that a copy is not permitted, then the recording device does not make the copy.

For some watermark technologies, a significant amount of content may need to be processed before the watermark embedded in the content is recognized and processed. Detection of the watermark and analysis of the copying rules is not instantaneous, and in some cases may take a considerable amount of time. In some instances, the content is encrypted, so detection of the watermark only takes place after some portion of the content is decrypted. For cases where the watermark is used in controlling copies, a recording device might wait to begin recording until the device detects the watermark and determines that the recording is permitted. However, for content received via an input mechanism not controlled by the recording device (e.g., in content streaming applications), this means that the recording device fails to record the first part of the content received from a source. This is typically unacceptable to the user (whose experience with the content is degraded if the first part is missing from the recorded copy). Buffering of content could be used to address this problem, but it could become a costly addition to the recording device if the data rate of the content is relatively high and the delay before watermark detection is relatively long.

Alternatively, the recording device may begin recording the received content immediately, and only stop the recording at a later point in time if the recording device subsequently detects a watermark that prohibits copying in the received content. This enables a permitted recording to include all of the received content, but it means that for content containing a watermark prohibiting recording, a partial “aborted” recording is made. If the recording media is of the type that can only be written once (e.g., digital versatile disk recordable (DVD-R)) or of a type that degrades appreciably with each recording (e.g., magnetic tape), this scenario is also unacceptable to a user because the media is then wasted due to the truncated content.

Generally, the use of watermarks can lead to transitory uncertainty in devices that must respond to the watermark, which in turn can lead to scenarios that are frustrating or unacceptable to users of such devices.

### BRIEF DESCRIPTION OF THE DRAWINGS

The features and advantages of the present invention will become apparent from the following detailed description of the present invention in which:

FIG. 1 is a diagram of a watermark detection and analysis system according to an embodiment of the present invention; and

FIG. 2 is a flow diagram illustrating watermark detection and associated data processing according to an embodiment of the present invention.

### DETAILED DESCRIPTION

An embodiment of the present invention is a method of using associated data to avoid transitory uncertainty caused by delayed watermark detection. In embodiments of the present invention, content embedded with a watermark is also accompanied by data that is loosely associated with the content and that corresponds with or mirrors the data contained in the watermark. In one embodiment, the associated data may be substantially the same as the watermark. These additional bits of data (referred to herein as “associated data”) are not hidden or encrypted in any way (unlike, in some cases, the main body of content containing the watermark, which may be encrypted), and can therefore be detected quickly by a device such as a recording device. If content is accompanied by associated data indicating that a copy is not permitted, then a recording device can ascertain very quickly upon receipt of the first portions of the content to not commence copying the content. In some embodiments, the associated data may be at or near the beginning of the incoming content stream. If, on the other hand, the associated data indicates that a copy is allowed, then the recording device may immediately begin making the copy. However, the recording device should not rely completely on the associated data in that case, since an interloper or “hacker” could easily change the associated data. Therefore, the recording device may still inspect the content for a watermark, and if one is subsequently detected that prohibits copying (i.e., it contradicts the associated data), then the watermark data takes precedence over the associated data and the copying may be aborted. Hence, the associated data may be used in conjunction with, but not in lieu of, a watermark, as a hint to avoid uncertainty before the watermark can be detected and processed. By detecting and analyzing the associated data early in the content reception and recording process, a recording device may capture all of the content and avoid making aborted copies (except for the case of a hacker changing the associated data).

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

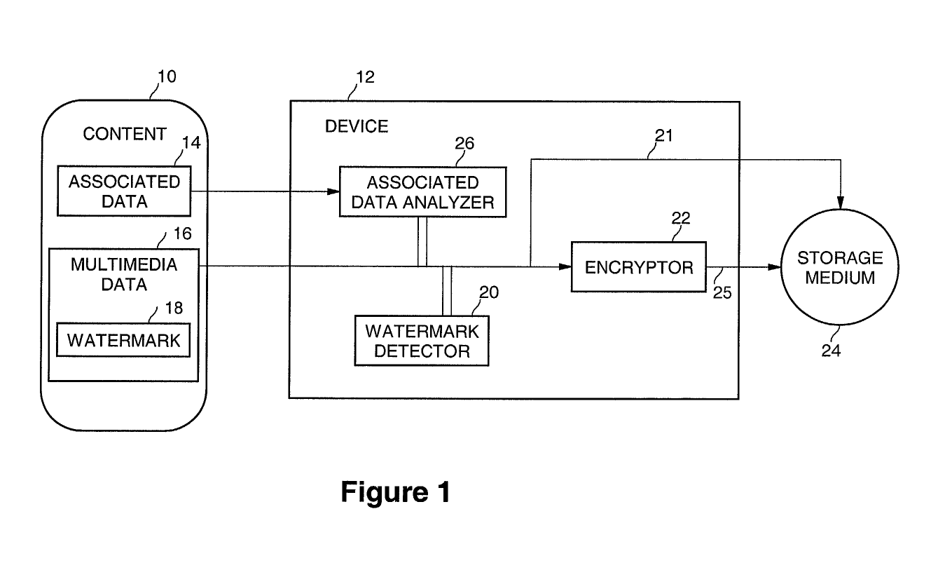

FIG. 1 is a diagram of a watermark detection and analysis system according to an embodiment of the present invention. Content 10, in analog or digital form, may be received from any content source by device 12 according to any manner of transmission or communication. In one embodiment, device 12 comprises a recording device and the content is streamed to the device. Content 10 comprises associated data 14, multimedia data 16, and watermark 18. Multimedia data may comprise any combination of audio, video, text, image, or other data. Watermark 18 may be embedded within multimedia data as part of a content protection scheme (watermark is shown as a separate block in FIG. 1 for explanatory purposes).

Watermarking is a technology that allows information to be embedded in content in a way that is intended to be transparent to the end-user of that content and robust against the information being removed or altered. The information stays with the content regardless of the content's analog or digital representation. Watermarking by itself does not protect content. When used as part of a content protection system, watermarking may be used to carry content management information (CMI). Sometimes referred to as usage rules, CMI is information carried with the content that indicates conditions and requirements constraining use of the content. CMI may include copy control information (CCI), which indicates constraints specific to copying. The protection comes from compliant devices such as device 12 responding appropriately to manage the content according to the CMI. Such protection is realized only if there is some means to compel devices to be compliant. Encryption is one way of scrambling content so that it is unusable unless it is first descrambled (decrypted) by a compliant device. In some cases, content 10 may be encrypted to protect multimedia data 16 from unauthorized access. In other cases, content 10 is unencrypted (“in the clear”).

Content 10 may be communicated to device 12. Upon reception, components within device 12 may process the received content. Watermark detector 20 analyzes multimedia data 16 to detect the watermark. If no watermark is detected, then the content may be processed by the device without restriction (e.g., stored on storage medium) (path 21). If a watermark is detected, the device determines, according to the CMI, if a copy can be made and whether the resulting copy should be encrypted. If a copy cannot be made of the content according to the CMI, the multimedia data may be discarded or ignored. If a copy can be made according to the CMI and the copy should be encrypted, the device forwards the multimedia data to encryptor 22. Encryptor 22 encrypts the content and the device stores the encrypted content in storage medium 24 (path 25). Prior to the above processing, if the incoming content is already encrypted, the content must first be decrypted prior to watermark detection and subsequent processing (decryptor not shown). The methods or algorithms used for encryption and decryption of the source content and encryption of content stored on the stored medium may be the same or different, depending on the embodiment.

Decryption of the content and watermark detection and analysis may take a significant amount of time. Prior to or in parallel with these activities, device 12 employs associated data analyzer 26 to analyze the incoming, unencrypted associated data to get an indication of the CMI prior to fully decrypting the content and detecting and analyzing the watermark. In embodiments of the present invention, this analysis may be accomplished in less time than decryption of the multimedia content and the embedded watermark, and detection and analysis of the watermark. If the associated data indicates that a copy is permitted, then the device may initiate copying of the content to the storage medium immediately, without waiting for watermark detector 20 to finish detection and analysis of the watermark. If the associated data indicates no copying is permitted, the content may be discarded or ignored. The associated data may be included in the copy of the content stored on the storage medium along with embedded watermark. The associated data may be created by the content creator or distributor or may be generated by a device “in the field” based on the watermark data for the content. When the content creator or distributor creates the associated data, the associated data may be attached to the content prior to distribution.

Note that the inconvenience of partial, aborted recordings can still occur with embodiments of the present invention, but it will only occur if the associated data has been tampered with. Such potential for user inconvenience as a result of tampering or hacking is not unique to this invention, since tampering with the content itself could cause a similar problem (e.g., recording of noise). The present invention overcomes potential user inconvenience caused by watermark-based content protection systems, and has wide applicability, including devices that process audio-visual content, and use by providers of such content.

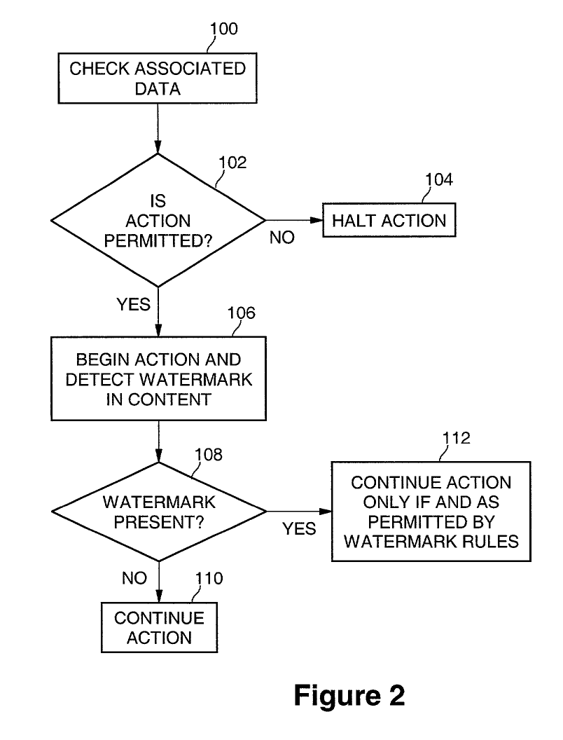

FIG. 2 is a flow diagram illustrating watermark detection and associated data processing according to an embodiment of the present invention. This processing may be performed by a device interacting with the content, such as a recording device. In other embodiments, the device may be a player or rendering device, a display, or other content processing device. At block 100, upon receiving at least a portion of the content, the device checks the received content for associated data. If the content includes associated data, the device examines the associated data to determine if an action requested by the user or other processing device is permitted by the CMI (e.g., the CCI or rules relating to copying if the requested action is copying of the content to a storage medium). The requested action may be copying, rendering, displaying, or other processing of the content. If the action is not permitted according to the associated data at block 102, then the requested action may be halted or prevented from occurring at block 104. If the requested action is permitted according to the associated rules, then the action may be begun immediately by the device at block 106 and the device may continue further processing in parallel to detect and analyze the watermark in the received content. Thus, the beginning of the requested action may occur prior to or in parallel with the detection and analysis of the watermark. At block 108, the device determines if a watermark is present in the received content. If no watermark is present, the device continues the requested action at block 110 (which is already in progress per block 108). If a watermark is present, the device continues the requested action already in progress only if and as permitted by the watermark rules (e.g., the CMI) at block 112.

Thus, embodiments of the present invention provide for avoiding transitory uncertainty caused by delayed watermark detection and analysis of content in a content protection system.

The techniques described herein are not limited to any particular hardware or software configuration; they may find applicability in any computing or processing environment. The techniques may be implemented in hardware, software, or a combination of the two. The techniques may be implemented in programs executing on programmable machines such as mobile or stationary computers, personal digital assistants, consumer electronics, set-top boxes, and other devices that each include a processor, a storage medium readable by the processor (including volatile and non-volatile memory and/or storage elements), at least one input device, and one or more output devices. Program code is applied to the data entered using the input device to perform the functions described and to generate output information. The output information may be applied to one or more output devices.

Each program may be implemented in a high level procedural or object oriented programming language to communicate with a processing system. However, programs may be implemented in assembly or machine language, if desired. In any case, the language may be compiled or interpreted.

Each such program may be stored on a storage medium or device, e.g., compact read only memory (CD-ROM), digital versatile disk (DVD), hard disk, magnetic disk, or other medium or device, that is readable by a general or special purpose programmable machine for configuring and operating the machine when the storage medium or device is read by the machine to perform the procedures described herein. The system may also be considered to be implemented as a machine-readable storage medium, configured with a program, where the storage medium so configured causes a machine to operate in a specific manner. Other embodiments are within the scope of the following claims.

While this invention has been described with reference to illustrative embodiments, this description is not intended to be construed in a limiting sense. Various modifications of the illustrative embodiments, as well as other embodiments of the invention, which are apparent to persons skilled in the art to which the inventions pertains are deemed to lie within the spirit and scope of the invention.

What is claimed is:

1. A method of avoiding transitory uncertainty caused by delayed watermark detection by a device in a content protection system comprising:
receiving content having a watermark from a content source;
receiving a request for action to process the received content;
checking the received content for data associated with the watermark; performing at least one of halting and preventing the requested action when associated data is found in the received content and the associated data indicates that the requested action is not permitted;
beginning the requested action when associated data is found in the received content and the associated data indicates that the requested action is permitted;
detecting and analyzing the watermark; and
continuing the requested action only if and as permitted by the watermark;
wherein beginning the requested action occurs at least one of prior to and in parallel with detection and analysis of the watermark.

2. The method of claim 1, wherein the associated data is unencrypted.

3. The method of claim 1, wherein the associated data comprises data substantially similar to the watermark.

4. The method of claim 1, wherein the associated data comprises content management information.

5. The method of claim 4, wherein the requested action is copying the received content, the device comprises a recording device, and the content management information comprises copy control information.

6. The method of claim 1, wherein the requested action is copying the received content and further comprising encrypting the received content and storing the encrypted content on a storage medium.

7. An article comprising: a storage medium having a plurality of machine readable instructions, wherein when the instructions are executed by a processor, the instructions provide for avoiding transitory uncertainty caused by delayed watermark detection by a device in a content protection system by receiving content having a watermark from a content source, receiving a request for action to process the received content, checking the received content for data associated with the watermark, performing at least one of halting and preventing the requested action when associated data is found in the received content and the associated data indicates that the requested action is not permitted, beginning the requested action when associated data is found in the received content and the associated data indicates that the requested action is permitted, and detecting and analyzing the watermark and continuing the requested action only if and as permitted by the watermark, wherein beginning the requested action occurs at least one of prior to and in parallel with detection and analysis of the watermark.

8. The article of claim 7, wherein the associated data is unencrypted.

9. The article of claim 7, wherein the associated data comprises data substantially similar to the watermark.

10. The article of claim 7, wherein the associated data comprises content management information.

11. The article of claim 10, wherein the requested action is copying the received content, the device comprises a recording device, and the content management information comprises copy control information.

12. The article of claim 11, wherein the requested action is copying the received content and further comprising instructions for encrypting the received content and storing the encrypted content on a second storage medium.

13. A system for avoiding transitory uncertainty caused by delayed watermark detection in received content having a watermark within a content protection system comprising:
an associated data analyzer to check the received content for data associated with the watermark, to perform at least one of halting and preventing a requested action when associated data is found in the received content and the associated data indicates that the requested action is not permitted; and to begin the requested action when associated data is found in the received content and the associated data indicates that the requested action is permitted; and
a watermark detector to detect the watermark in the received content, to analyze the watermark, and to continue the requested action only if and as permitted by the watermark.

14. The system of claim 13, wherein the associated data analyzer begins the requested action at least one of prior to and in parallel with detection and analysis of the watermark by the watermark detector.

15. The system of claim 13, wherein the associated data is unencrypted.

16. The system of claim 13, wherein the associated data comprises data substantially similar to the watermark.

17. The system of claim 13, wherein the associated data comprises content management information.

18. The system of claim 17, wherein the requested action is copying the received content, the system comprises a recording device, and the content management information comprises copy control information.

19. The system of claim 17, wherein the requested action is copying the received content and further comprising an encryptor to encrypt the received content prior to storage of the encrypted content on a storage medium.

20. A method of distributing content having a watermark comprising:
creating associated data indicating copy control information for the content in addition to the watermark to the content;
attaching the associated data to the content; and
distributing the content and the associated data to a user;
wherein the associated data is used by a recording device receiving the content to perform at least one of halting and preventing copying of the content when the associated data indicates that copying of the content is not permitted, and beginning copying the content at least one of prior to or in parallel with detecting and analyzing the watermark when the associated data indicates copying of the content is permitted.

21. The method of claim 20, wherein the associated data is unencrypted.

22. The method of claim 20, wherein the recording device detects and analyzes the watermark in the content and continues copying the content only if and as permitted by the watermark.

23. A multimedia content data structure comprising:
multimedia data, the multimedia data including a watermark indicating content management information; and
associated data indicating content management information.

24. The multimedia content data structure of claim 23, wherein the content management information comprises copy control information, the multimedia data is encrypted, and the associated data is unencrypted.
